(19) United States
(12) Patent Application Publication
(10) Pub. No.: US 2026/0014852 A1
(43) Pub. Date: Jan. 15, 2026

(54) DRIVE ASSEMBLY, AXLE AND WORK MACHINE

(71) Applicant: Deere & Company, Moline, IL (US)

(72) Inventor: KRUTIN VINODKUMAR RAJANI, BACKNANG (DE)

(21) Appl. No.: 19/225,308

(22) Filed: Jun. 2, 2025

(30) Foreign Application Priority Data
Jul. 12, 2024 (EP) 24188294.3

(51) Int. Cl. B60K 17/28; B60K 17/16

(52) U.S. Cl. CPC B60K 17/28; B60K 17/16; B60Y 2200/221

(57) ABSTRACT

A drive assembly for a work machine includes a first and a second energy machine, a travel drive, a first power output, and a plurality of coupling devices equal to one more than a sum of at least two drive stages at the travel drive and shift points at the first power output, the first energy machine being connectable by at least one of the plurality of coupling devices to the travel drive, the second energy machine being connectable by at least one of the plurality of coupling devices to the travel drive, and the second energy machine being connectable by at least one of the plurality of coupling devices to the first power output.

### CROSS-REFERENCE TO RELATED APPLICATIONS

This application claims priority to European Patent Application No. 24188294.3, filed Jul. 12, 2024, which is hereby incorporated by reference.

### FIELD OF THE DISCLOSURE

The disclosure relates to a drive assembly for a work machine.

### BACKGROUND

Work machines, for example construction machines or agricultural work vehicles, such as agricultural towing vehicles or farm tractors, are commonly powered by internal combustion engines. In this context, the internal combustion engine can drive one or more axles of the work machine, in particular a rear axle and/or a front axle. The one or more axles are usually driven by the crankshaft of the internal combustion engine via a transmission having a variable transmission ratio and one or more travel drives, in particular one or more differentials. The travel drive, in particular the differential, can be connected in terms of drive on the driven side to the shafts of the wheels, in particular of the front and/or rear wheels.

The internal combustion engine can likewise additionally drive a first power output, in particular a mechanical power output. More specifically, the internal combustion engine can drive a power take-off unit, in particular a power take-off shaft. The power take-off unit can be situated on a rear side of the work machine, in particular in the vicinity of an attachment interface for implements.

### SUMMARY

According to an aspect of the present disclosure, a drive assembly for a work machine includes a first and a second energy machine, a travel drive, a first power output, and a plurality of coupling devices equal to one more than a sum of at least two drive stages at the travel drive and shift points at the first power output, the first energy machine being connectable by at least one of the plurality of coupling devices to the travel drive, the second energy machine being connectable by at least one of the plurality of coupling devices to the travel drive, and the second energy machine being connectable by at least one of the plurality of coupling devices to the first power output.

According to an aspect of the present disclosure, the first energy machine is connectable via a first coupling device of the plurality of coupling devices to the travel drive, the second energy machine is connectable via a second coupling device of the plurality of coupling devices to the first power output, the second energy machine is connectable via a third coupling device of the plurality of coupling devices to the travel drive, and the first energy machine is connectable via a fourth coupling device of the plurality of coupling devices to the first power output.

According to an aspect of the present disclosure, the first energy machine is connected to the travel drive, the second energy machine is connected to the first power output when a rotational speed of the first energy machine is less than or equal to a rotational speed threshold value, and the second energy machine is connected to the travel drive when the rotational speed of the first energy machine is greater than the rotational speed threshold value.

According to an aspect of the present disclosure, the second energy machine is connected to the travel drive and to the first power output when the rotational speed of the first energy machine is greater than the rotational speed threshold value, or the second energy machine is connected to the travel drive, and the first energy machine is connected to the first power output, when the rotational speed of the first energy machine is greater than the rotational speed threshold value.

According to an aspect of the present disclosure, the drive assembly further includes a second power output.

According to an aspect of the present disclosure, the first energy machine is connected to the travel drive, the second energy machine is connected to the first and the second power output or to the second power output when a rotational speed of the first energy machine is less than a rotational speed threshold value, and the second energy machine is connected to the travel drive when the rotational speed of the first energy machine is greater than the rotational speed threshold value.

According to an aspect of the present disclosure, the drive assembly further includes a third energy machine being connected to the second power output.

According to an aspect of the present disclosure, one of the first power output includes a first angular gear set and a second angular gear set, or the second power output includes the second angular gear set.

According to an aspect of the present disclosure, the first, second, and third energy machines and the travel drive are arranged coaxially with or parallel to one another.

According to an aspect of the present disclosure, a work machine includes the drive assembly disclosed herein.

According to an aspect of the present disclosure, an axle for a work machine includes a drive assembly disclosed herein.

According to an aspect of the present disclosure, a work machine includes an axle having a drive assembly disclosed herein.

The above and other features will become apparent from the following detailed description and accompanying drawings.

### BRIEF DESCRIPTION OF THE DRAWINGS

The disclosure and other advantages and advantageous developments and embodiments of the disclosure are explained in greater detail below both in terms of hardware and in terms of method, on the basis of example embodiments and with reference to the drawings. Component parts of equivalent or comparable function are designated here by the same reference signs. In the drawings:

FIG. 1 shows a schematic illustration of a first example embodiment of a work machine according to the disclosure, in particular an agricultural towing vehicle in the form of a farm tractor;

FIG. 2 shows a schematic illustration of the first example embodiment of the drive assembly according to the disclosure;

FIG. 3 shows a schematic illustration of a second example embodiment of the drive assembly according to the disclosure;

FIG. 4 shows a schematic illustration of a third example embodiment of the drive assembly according to the disclosure;

FIG. 5 shows a schematic illustration of a fourth example embodiment of the drive assembly according to the disclosure;

FIG. 6 shows a schematic illustration of a fifth example embodiment of the drive assembly according to the disclosure;

FIG. 7 shows a schematic illustration of a sixth example embodiment of the drive assembly according to the disclosure;

FIG. 8 shows a schematic illustration of a seventh example embodiment of the drive assembly according to the disclosure;

FIG. 9 shows a schematic illustration of an eighth example embodiment of the drive assembly according to the disclosure;

FIG. 10 shows a schematic illustration of a ninth example embodiment of the drive assembly according to the disclosure;

FIG. 11 shows a schematic illustration of a tenth example embodiment of the drive assembly according to the disclosure;

FIG. 12 shows a schematic illustration of a further example embodiment of the drive assembly according to the disclosure; and

FIG. 13 shows a schematic illustration of a further example embodiment of the drive assembly according to the disclosure.

### DETAILED DESCRIPTION

The embodiments or implementations disclosed in the above drawings and the following detailed description are not intended to be exhaustive or to limit the present disclosure to these embodiments or implementations.

There are currently proposals for powering work machines of this kind by means of electric motors, in particular as purely battery-operated vehicles. One approach would be to transfer the existing drivetrain (constructed with a shaft extending in the longitudinal direction, but now driven by electric motor, and with a differential) to such vehicles, as is disclosed in US 2023/0227106 A1. DE 10 2008 032 848 A1 discloses an axle for a work vehicle, in particular an industrial truck, having a differential which is connected in terms of drive on the driven side to the shafts of the rear wheels. The differential is driven by an electric motor via a hollow shaft, which coaxially surrounds one of the shafts of the rear wheels. For its part, the hollow shaft is driven via an electric motor designed as an internal-rotor motor, which is fitted around the hollow shaft. DE 10 2020 114 063 A1 discloses a similar arrangement for a final drive of a motor vehicle, but with a gear mechanism between the electric motor and the hollow shaft and a shift transmission between the hollow shaft and the differential.

In some approaches, the power take-off shaft is driven by the internal combustion engine, wherein a superposition gear mechanism coupled to an additional electric motor can be used for setting the rotational speed (DE 10 2017 205 149 A1, EP 1 466 773 A2). In the case of purely electric drives, it has been proposed to drive the power take-off shaft by means of a first electric motor, which is connected by a superposition gear mechanism to the travel drive, whilst the superposition gear mechanism is also driven by a further electric motor (DE 10 2019 106 294 A1).

The disadvantage of the known drive assemblies is that they do not allow powershifting, in particular they cannot be shifted seamlessly, and/or they do not have a sufficient number of gear ratios for the travel drive and/or the first power output. Moreover, it is disadvantageous that the known drive assemblies are too complicated or complex in terms of their structural design.

Based on these approaches, it is an object of the present disclosure to propose a drive assembly, an axle and a work machine which largely avoid the disadvantages known from these approaches. The present disclosure is therefore based, in particular, on the object of proposing a drive assembly, an axle and a work machine by means of which the aforementioned problems are overcome. More specifically, it is an object of the present disclosure to propose a drive assembly, an axle and a work machine which are of simple structural design and/or have a plurality of gear ratios and/or are of lower-cost configuration and/or can for example be shifted seamlessly and in a synchronized manner.

This object is achieved by a drive assembly having the features of one or more of the embodiments disclosed herein. Some of the embodiments can relate to particularly advantageous embodiments of the disclosure.

According to the disclosure, a drive assembly for a work machine is proposed. More specifically, what is proposed is, in particular, a drive assembly for an axle of a work machine, for example an electrically driven axle of a work machine. The drive assembly comprises a first and a second electric motor, a travel drive and a first power output. Furthermore, it is possible by means of the drive assembly to implement m≥2 drive stages, for example shiftable drive stages, such as seamlessly shiftable shift stages, at the travel drive and t≥0 shift points at the first power output, for example seamlessly shiftable shift points at the first power output. The drive stages may be gear ratios or transmission ratios or transmission stages. In other words, the drive assembly comprises m≥2 drive stages at the travel drive and t≥0 shift points at the first power output. Specifically, the drive assembly is settable and/or adjustable and/or controllable into m≥2 drive stages at the travel drive and t≥0 shift points at the first power output. The drive assembly comprises x=m+t+1 coupling devices, the first energy machine being connectable by a coupling device to the travel drive, and the second energy machine being connectable by in each case at least one coupling device to the travel drive and to the first power output.

The first and the second energy machine can be designed as electric motors, in particular as a first and a second electric motor. Alternatively, the first and the second energy machine can be designed as fuel cells, in particular as a first and a second fuel cell. However, the first and/or the second energy machine can also be a permanent-magnet and/or electrically excited synchronous and/or asynchronous machine that is operated using direct current and/or three-phase current, for example a permanent-magnet three-phase synchronous machine. The first and the second energy machine can be operable as motors or as generators. The first and the second energy machine can drive the drive assembly with a rotational speed and/or a torque. The first energy machine, in particular the first electric motor, can comprise a first drive shaft. The second energy machine, in particular the second electric motor, can comprise a second drive shaft.

The drive assembly, in particular the axle or the work machine, can comprise one or more energy stores. The energy store or stores can be connected and/or couplable, in particular electrically connected and/or electrically couplable, to the first and/or the second energy machine. The energy store can be an electrical energy store. The energy store can supply the connected energy machine(s) with energy, in particular electrical energy. The energy store can be designed as a battery and/or a rechargeable battery and/or a supercapacitor and/or a fuel cell and/or some other device for storing electrical energy.

Connected can for example be understood as meaning mechanically connected, such as driveably connected, i.e. connected in a torque-transmitting and/or rotational-speed-transmitting manner, and/or coupled or couplable, i.e. mechanically coupled or mechanically couplable. Mechanically connected, for example driveably connected and/or coupled or couplable, or mechanically coupled or mechanically couplable, can therefore be understood as meaning in particular a connection of two components which makes it possible to transmit energy and/or force and/or torque and/or a rotational speed from one component to the other, in particular mechanically. Further components or parts enabling such a transmission of energy and/or force and/or torque and/or transmission of a rotational speed between the two components can be provided between the two components.

The travel drive can comprise a first output shaft and/or be designed as a first output shaft. The travel drive can likewise comprise a differential and the first output shaft. In this instance, the differential can be connected on the drive side to the first output shaft. In addition, the differential can be connected on the driven side to a left-hand shaft and to a right-hand shaft in order to drive ground-engaging means on the axle. The first output shaft can be designed as a hollow shaft, which, in particular, partially or completely surrounds the left-hand and/or right-hand shaft.

The first power output can comprise a second output shaft and/or be designed as a second output shaft. Likewise, the first power output can additionally comprise a power take-off unit. The power take-off unit can comprise a power take-off transmission and/or a power take-off shaft. The power take-off unit, in particular the power take-off transmission, can be connected on the drive side to the second output shaft. Moreover, the power take-off unit, in particular the power take-off transmission, can be connectable or connected on the driven side to the power take-off shaft.

The coupling devices can each be movable between a first position, in particular a closed or connected or coupled state, and a second position, in particular an open or unconnected or decoupled state. In the first position, the respective coupling devices can be connected to another component, for example the first or the second output shaft. In the second position, it is possible for the respective coupling devices not to be connected to the other component, i.e. to be released or decoupled therefrom.

The coupling devices can each be designed as a clutch or synchronizer, for example as a shift clutch or a multiplate clutch or a synchromesh clutch or a switchable freewheel clutch.

The drive assembly can comprise one or more transmission stages, in particular a spur gear stage or a gearwheel set or a gearwheel pair. The drive assembly may comprise 1 to z transmission stages, where z≤x.

The drive assembly or the work machine or the axle can comprise a control unit. The control unit can be connected to the first and the second energy machine for signaling, and/or operatively coupled thereto and/or connected thereto for transmitting signals and/or carrying data. The control unit can be configured to receive one or more rotational speed signals and/or torque signals from the drive assembly, in particular from rotational speed and/or torque sensors of the drive assembly, and/or from the first and/or the second energy machine. The control unit can be configured to ascertain a rotational speed and/or a torque by means of the rotational speed signal and/or the torque signal. The control unit can be configured to set and/or adjust, in particular also to operate, the rotational speed and/or the torque of the drive assembly, in particular of the first and the second energy machine.

The coupling devices can be connected to a control unit for signaling, and/or operatively coupled thereto and/or connected thereto for transmitting signals and/or carrying data. In particular, each coupling device can comprise a valve or a valve assembly, in particular a control valve, or an actuator for controlling and/or setting and/or adjusting the respectively associated coupling device. The valve or the valve assembly or the actuator can be connected and/or operatively coupled to the respectively associated coupling device.

The control unit can be connected to the valve or to the valve assembly or to the actuator for signaling, and/or operatively coupled thereto and/or connected thereto for transmitting signals and/or carrying data. The control unit can be configured to control and/or set and/or adjust the coupling devices, in particular via or by means of the respectively associated valve or the valve assembly or the actuator. The control unit can be configured to set and/or adjust the coupling device, in particular via or by means of the respectively associated valve or the valve assembly or the actuator, into the first or the second position, in particular also to move said coupling device from the first into the second position and vice versa.

An m-gear transmission with shift capability, in particular synchronous shift capability, between the first and the second energy machine can be achieved by means of odd-numbered and even-numbered transmission ratios at the two energy machines. For example, for a 4-gear synchronous shift transmission, the first energy may have gears 1 and 3 and the second energy machine may have gears 2 and 4. The number of coupling devices required for an m-gear shift transmission is likewise m, one for each gear of the corresponding energy machine.

The synchronized shifting of the first power output can be achieved only for the shifting of a gear selector lever. For other gearshift operations, in order to allow synchronized shifting of the power take-off drive, a greater number of transmission ratios and coupling devices are required for the first power output.

The drive assembly thus comprises a travel drive and a first power output, for example a first mechanical power output and a mechanical travel drive, such as an electrically driven first mechanical power output and an electrically driven first mechanical travel drive. The first and the second energy machine can alternately drive both the travel drive and the first power output. It is thereby possible to provide a plurality of gears with the respectively desired rotational speed and/or torque for the drive assembly. Moreover, synchronized shifting of gears can be made possible without a second gear actually being required for one of the energy machines. Seamless shifting of gears can also be implemented. It is possible to dispense with a transmission that has a variable transmission ratio. In this way, a compact construction of the drive assembly is furthermore obtained. Further gears and coupling devices can be added to the drive assembly, thus making it possible to implement an n-gear shift configuration. It is in particular also possible to implement an n-gear synchronized and/or seamless drive assembly.

In one embodiment of the disclosure, the drive assembly comprises a first and/or a second and/or a third and/or a fourth coupling device. The first energy machine can be connected to the first coupling device. In addition, the first energy machine can be connectable or connected, in particular also releasably connected, to the first coupling device or via the first coupling device to the travel drive. For this purpose, the first drive shaft can be connected to the first coupling device. Alternatively or in addition, the second energy machine can be connected to the second coupling device. In addition, the second energy machine can be connectable or connected, in particular also releasably connected, to the second coupling device or via the second coupling device to the first power output. For this purpose, the second drive shaft can be connected to the second coupling device. The first coupling device can be connectable or connected to the first output shaft. The second coupling device can be connectable or connected to the second output shaft. In addition or alternatively, the second energy machine can be connected to the third coupling device. In addition or alternatively, the second energy machine can be connectable or connected, in particular also releasably connected, by means of or by the third coupling device to the travel drive. The third coupling device can be connectable or connected to the first output shaft. In addition or alternatively, the first energy machine can be connected to the fourth coupling device. In addition or alternatively, the first energy machine can be connectable or connected, in particular also releasably connected, by means of or by the fourth coupling device to the first power output. The fourth coupling device can be connectable or connected to the second output shaft.

By means of or by the first coupling device, it is possible for the first energy machine to be connected to the travel drive, in particular the first output shaft, in the first position and not to be connected to the travel drive, in particular the first output shaft, i.e. to be decoupled, in the second position. By means of or by the second coupling device, it is possible for the second energy machine to be connected to the first power output, in particular the second output shaft, in the first position and not to be connected to the first power output, in particular the second output shaft, i.e. to be decoupled, in the second position.

The drive assembly can comprise a first transmission stage, in particular a first spur gear stage or a first gearwheel set or a first gearwheel pair. The first energy machine can be connected by or by means of the first transmission stage to the first coupling device. The drive assembly can comprise a second transmission stage, in particular a second spur gear stage or a second gearwheel set or a second gearwheel pair. The second energy machine can be connected by or by means of the second transmission stage to the second coupling device.

The first and/or the second coupling device can be connected to the control unit for signaling, and/or operatively coupled thereto and/or connected thereto for transmitting signals and/or carrying data. In particular, the drive assembly can comprise a first valve or a first valve assembly, in particular a first control valve, or a first actuator for controlling and/or setting and/or adjusting the first coupling device. The first valve or the first valve assembly or the first actuator can be connected to the first coupling device. The drive assembly can likewise comprise a second valve or a second valve assembly, in particular a second control valve, or a second actuator for controlling and/or setting and/or adjusting the second coupling device. The second valve or the second valve assembly or the second actuator can be connected to the second coupling device.

The control unit can be connected to the first and/or the second valve or to the first and/or the second valve assembly or to the first and/or the second actuator for signaling, and/or operatively coupled thereto and/or connected thereto for transmitting signals and/or carrying data. The control unit can be configured to control and/or set and/or adjust the first coupling device, in particular via or by means of the first valve or the first valve assembly or the first actuator. The control unit can be configured to set and/or adjust the first coupling device, in particular via or by means of the first valve or the first valve assembly or the first actuator, into the first or the second position, in particular also to move said first coupling device from the first into the second position and vice versa. The control unit can be configured to control and/or set and/or adjust the second coupling device, in particular via or by means of the second valve or the second valve assembly or the second actuator. The control unit can be configured to set and/or adjust the second coupling device, in particular via or by means of the second valve or the second valve assembly or the second actuator, into the first or the second position, in particular also to move said second coupling device from the first into the second position and vice versa. The drive assembly has the advantages set out above.

By means of or by the fourth coupling device, it is possible for the first energy machine to be connected to the first power output, in particular the second output shaft, in the first position and not to be connected to the first power output, in particular the second output shaft, i.e. to be decoupled, in the second position. By means of or by the third coupling device, it is possible for the second energy machine to be connected to the travel drive, in particular the first output shaft, in the first position and not to be connected to the travel drive, in particular the first output shaft, i.e. to be decoupled, in the second position.

The drive assembly can comprise a third transmission stage, in particular a third spur gear stage or a third gearwheel set or a third gearwheel pair. The second energy machine can be connected by or by means of the third transmission stage to the third coupling device. The drive assembly can comprise a fourth transmission stage, in particular a fourth spur gear stage or a fourth gearwheel set or a fourth gearwheel pair. The first energy machine can be connected by or by means of the fourth transmission stage to the fourth coupling device.

The third and/or the fourth coupling device can be connected to the control unit for signaling, and/or operatively coupled thereto and/or connected thereto for transmitting signals and/or carrying data. In particular, the drive assembly can comprise a third valve or a third valve assembly, in particular a third control valve, or a third actuator for controlling and/or setting and/or adjusting the third coupling device. The third valve or the third valve assembly or the third actuator can be connected to the third coupling device. The drive assembly can likewise comprise a fourth valve or a fourth valve assembly, in particular a fourth control valve, or a fourth actuator for controlling and/or setting and/or adjusting the fourth coupling device.

The fourth valve or the fourth valve assembly or the fourth actuator can be connected to the fourth coupling device.

The control unit can be connected to the third and/or the fourth valve or to the third and/or the fourth valve assembly or to the third and/or the fourth actuator for signaling, and/or operatively coupled thereto and/or connected thereto for transmitting signals and/or carrying data. The control unit can be configured to control and/or set and/or adjust the third coupling device, in particular via or by means of the third valve or the third valve assembly or the third actuator. The control unit can be configured to set and/or adjust the third coupling device, in particular via or by means of the third valve or the third valve assembly or the third actuator, into the first or the second position, in particular also to move said third coupling device from the first into the second position and vice versa. The control unit can be configured to control and/or set and/or adjust the fourth coupling device, in particular via or by means of the fourth valve or the fourth valve assembly or the fourth actuator. The control unit can be configured to set and/or adjust the fourth coupling device, in particular via or by means of the fourth valve or the fourth valve assembly or the fourth actuator, into the first or the second position, in particular also to move said fourth coupling device from the first into the second position and vice versa. The above-described advantages of the drive assembly can thus be achieved.

In one embodiment of the disclosure, the first energy machine is connected to the travel drive, and the second energy machine is connected to the first power output, when a rotational speed of the first energy machine is less than or equal to a rotational speed threshold value, for example when a rotational speed of the first energy machine is less than the rotational speed threshold value, and the second energy machine is connected to the travel drive when a rotational speed of the first energy machine is greater than the rotational speed threshold value. Alternatively or in addition, the second energy machine can be connected to the travel drive and to the first power output when the rotational speed of the first energy machine is greater than the rotational speed threshold value, or the second energy machine can be connected to the travel drive, and the first energy machine connected to the first power output, when the rotational speed of the first energy machine is greater than the rotational speed threshold value. It is possible in particular for only the first energy machine to be connected to the travel drive, and in particular for only the second energy machine to be connected to the first power output, when a torque of the first energy machine is less than or equal to the torque threshold value and/or a rotational speed of the first energy machine is less than or equal to the rotational speed threshold value, for example when a torque of the first energy machine is less than the torque threshold value and/or a rotational speed of the first energy machine is less than the rotational speed threshold value. It is alternatively or additionally possible in particular for only the second energy machine to be connected to the travel drive when a torque of the first energy machine is greater than the torque threshold value and/or a rotational speed of the first energy machine is greater than the rotational speed threshold value.

The control unit can be configured to ascertain a rotational speed and/or a torque by means of the rotational speed signal and/or the torque signal. The control unit can be configured to compare the ascertained rotational speed and/or the ascertained torque with the rotational speed threshold value n_{threshold} and/or the torque threshold value T_{threshold}. The control unit can be configured to set and/or adjust the drive assembly, in particular the first and the second energy machine, into the first or the second mode, in particular to operate same in the first or the second mode, in accordance with the rotational speed and/or the torque. The control unit can be configured to set and/or adjust the drive assembly, in particular the first and the second energy machine, into the first mode, in particular to operate same in the first mode, in accordance with the rotational speed and/or the torque when the torque of the first energy machine is less than or equal to the torque threshold value and/or the rotational speed of the first energy machine is less than or equal to the rotational speed threshold value, when the torque of the first energy machine is less than the torque threshold value and/or the rotational speed of the first energy machine is less than the rotational speed threshold value. Alternatively or in addition, the control unit can be configured to set and/or adjust the drive assembly, in particular the first and the second energy machine, into the second mode, in particular to operate same in the second mode, in accordance with the rotational speed and/or the torque when the torque of the first energy machine is greater than the torque threshold value and/or the rotational speed of the first energy machine is greater than the rotational speed threshold value. The control unit can be configured to set and/or adjust and/or control, i.e. in particular also to exercise open-loop and closed-loop control over, the drive assembly and thus also the work machine by means of or in accordance with the rotational speed and/or the torque of the first energy machine. The control unit may thus be configured to set and/or adjust, in particular to increase or decrease, the energy and/or the torque and/or the force and/or the rotational speed of the drive assembly, in particular of the first and the second energy machine, in accordance with the rotational speed and/or the torque.

Based on the classification whereby the torque of the first energy machine can be less than the torque threshold value or greater than or equal to the torque threshold value, and/or the rotational speed of the first energy machine can be less than or greater than or equal to the rotational speed threshold value, two modes of the drive assembly and/or of the work machine are defined. In other words, two speed ranges of the drive assembly and/or of the work machine are defined. The first mode or first speed range prevails when the torque of the first energy machine is less than or equal to the torque threshold value and/or the rotational speed of the first energy machine is less than or equal to the rotational speed threshold value, that is to say when the following applies:

$$n \leq {n}_{threshold} and / or T \leq {T}_{threshold}$$

or when the torque of the first energy machine is less than the torque threshold value and/or the rotational speed of the first energy machine is less than the rotational speed threshold value, that is to say when the following applies:

$$n < {n}_{threshold} and / or T < {T}_{threshold}$$

where
n=rotational speed of the first energy machine
n_{threshold}=rotational speed threshold value, in particular the maximum rotational speed of the first energy machine
T=torque of the first energy machine
T_{threshold}=torque threshold value, in particular the maximum torque of the first energy machine

A shift point may be present when n=n_{threshold} and/or T=T_{threshold} applies. Thus, if the rotational speed n of the first energy machine corresponds to the rotational speed threshold value n_{threshold}, i.e. in particular if n=n_{threshold} applies and/or if the torque T corresponds to the torque threshold value T_{threshold}, i.e. if T=T_{threshold} applies, a gear change, in particular a synchronized gear change to the second mode or the second speed range, takes place. The gear change can take place under full load and without an interruption in tractive power and, in particular, can take place seamlessly. The first and the second energy machine can have the same rotational speed at the shift point, i.e. in particular if n=n_{threshold} and/or T=T_{threshold} applies. Owing to the seamless shifting, vibrations and/or shaking (“shift shock”) of the drive assembly can be avoided.

The second mode or second speed range prevails when the torque of the first energy machine is greater than the torque threshold value and/or the rotational speed of the first energy machine is greater than the rotational speed threshold value, that is to say when the following applies:

$$n > {n}_{threshold} and / or T > {T}_{threshold}$$

where
n=rotational speed of the first energy machine
n_{threshold}=rotational speed threshold value, in particular the maximum rotational speed of the first energy machine
T=torque of the first energy machine
T_{threshold}=torque threshold value, in particular the maximum torque of the first energy machine

In the first mode or the first speed range, the following applies, it being possible, in particular, for the drive assembly to be operable as follows in the first mode or the first speed range:

The first energy machine, in particular only the first energy machine, is connected, in particular coupled, to the travel drive, and the travel drive can be driven by means of the first energy machine. The first energy machine can thus act as the sole machine providing torque and/or rotational speed, i.e. in particular traction, for the travel drive. Thus, the drive assembly, and in particular at low speeds (n<n_{threshold} and/or T<T_{threshold}) the work machine, can be used with a constant single transmission ratio. Moreover, a high traction torque and high tractive power of the work machine can be made possible at low speeds.

The second energy machine, in particular only the second energy machine, is connected, in particular coupled, to the first power output, and the first power output can be driven by means of the second energy machine. Said second energy machine can thus act as the sole machine providing torque and/or rotational speed for the first power output.

In the second mode or the first speed range, the following applies, it being possible, in particular, for the drive assembly to be operable as follows in the second mode or the second speed range:

The second energy machine, in particular only the second energy machine, is connected, in particular coupled, to the travel drive, and the travel drive can be driven by means of the second energy machine. The first energy machine can be decoupled from the travel drive.

Proceeding from this rotational speed and/or this torque, the first energy machine no longer provides any torque and/or rotational speed, in particular traction, for the travel drive, and only the second energy machine provides the torque and/or the rotational speed, in particular the full traction, for the travel drive.

It is additionally possible for the first energy machine, in particular only the first energy machine, to be connected, in particular coupled, to the first power output, and for the first power output to be driveable by means of the first energy machine. Said first energy machine can thus act as the sole machine providing torque and/or rotational speed for the first power output. Depending on the transmission ratios selected, it is thereby also possible to achieve synchronized shifting of the first power output.

In other words, the control unit can be connected to the first and the second energy machine for signaling, and/or operatively coupled thereto and/or connected thereto for transmitting signals and/or carrying data. The control unit can be configured to receive one or more rotational speed signals and/or torque signals from the drive assembly, in particular from rotational speed and/or torque sensors of the drive assembly, and/or from the first and/or the second energy machine. The control unit can be configured to ascertain a rotational speed and/or a torque by means of the rotational speed signal and/or the torque signal. The control unit can be configured to compare the ascertained rotational speed and/or the ascertained torque with the rotational speed threshold value n_{threshold} and/or the torque threshold value T_{threshold}. The control unit can be configured to set and/or adjust, in particular also to operate, the rotational speed and/or the torque of the drive assembly, in particular of the first and the second energy machine. The control unit can be configured to set and/or adjust the drive assembly, in particular the first and the second energy machine, into the first or the second mode, in particular to operate same in the first or the second mode, in accordance with the rotational speed and/or the torque. The control unit can be configured to set and/or adjust the drive assembly, in particular the first and the second energy machine, into the first mode, in particular to operate same in the first mode, in accordance with the rotational speed and/or the torque when the torque of the first energy machine is less than the torque threshold value and/or the rotational speed of the first energy machine is less than the rotational speed threshold value. Alternatively or in addition, the control unit can be configured to set and/or adjust the drive assembly, in particular the first and the second energy machine, into the second mode, in particular to operate same in the second mode, in accordance with the rotational speed and/or the torque when the torque of the first energy machine is greater than the torque threshold value and/or the rotational speed of the first energy machine is greater than the rotational speed threshold value. The control unit can be configured to set and/or adjust and/or control, i.e. in particular also to exercise open-loop and closed-loop control over, the drive assembly and thus also the work machine by means of or in accordance with the rotational speed and/or the torque of the first energy machine. The control unit may thus be configured to set and/or adjust, in particular to increase or decrease, the energy and/or the torque and/or the force and/or the rotational speed of the drive assembly, in particular of the first and the second energy machine, in accordance with the rotational speed and/or the torque.

The drive assembly has the advantages set out above. In addition, these measures enable the selection of various stages or gears or transmission ratios. As illustrated by way of example in Table 1, it is possible, depending on how the coupling units are shifted, that is to say whether they are in the first or the second position, for only the travel drive, only the first power output, or the travel drive and the first power output, or the boosted travel drive and/or the boosted first power output, to be used. The different rotational speeds of the travel drive and/or of the first power output or the speed of the work machine depend on the transmission ratios selected between the first and the second energy machine. Moreover, the travel range can be restricted, depending on the transmission ratio. Moreover, the modes shown in Table 1 are based, for example, on a second energy machine with a higher power than the first energy machine. Depending on the configuration of the transmission stages and of the energy machines, a certain sequence must be maintained in the shifting of the coupling devices in order to achieve synchronized shifting of the drive assembly.

TABLE 1
The various stages of the drive assembly with four coupling devices

| Stage | K1 | K2 | K3 | K4 | State | Mode |
|---|---|---|---|---|---|---|
| 1 | Closed | Open | Open | Open | Drive EM1 - travel drive | Only driving |
| 2 | Open | Open | Closed | Open | Drive EM2 - travel drive | Only driving |
| 3 | Closed | Open | Closed | Open | Drive EM1 and EM2 - travel drive | Power boosting, driving |
| 4 | Open | Closed | Open | Open | Drive EM2 - first power output | Only power output |
| 5 | Open | Open | Open | Closed | Drive EM1 - first power output | Only power output |
| 6 | Open | Closed | Open | Closed | Drive EM1 and EM2 - first power | Power boosting, first |
| | | | | | output | power output |
| 7 | Closed | Closed | Open | Open | Drive EM1 - travel drive and | Driving and power |
| | | | | | EM2 - first power output | output |
| 8 | Open | Open | Closed | Closed | Drive EM2 - travel drive and | Driving and power |
| | | | | | EM1 - first power output | output |
| 9 | Closed | Closed | Closed | Open | Drive EM1 and EM2 - travel drive | Power boosting, driving |
| | | | | | and EM2 - first power output | and power output |
| 10 | Closed | Closed | Open | Closed | Drive EM1 - travel drive and | Power boosting, driving |
| | | | | | EM1 and EM2 - first power output | and power output |
| 11 | Open | Closed | Closed | Closed | Drive EM2 - travel drive and | Power boosting, driving |
| | | | | | EM1 and EM2 - first power output | and power output |
| 12 | Open | Closed | Closed | Open | Drive EM2 - travel drive and | Power output, high |
| | | | | | first power output | rotational speed |
| 13 | Closed | Open | Open | Closed | Drive EM1 - travel drive and | Power output, low |
| | | | | | first power output | rotational speed |
| 14 | Open | Open | Open | Open | Neutral, no drive | Neutral |

Specifically, m modes or speed ranges of the drive assembly and/or of the work machine and/or of the axle can be defined. The number of modes can thus correspond to the number of drive stages.

The m−1 mode or m−1 speed range can prevail when the torque of the first energy machine is less than or equal to an m-th torque threshold value T_{threshold,m} and/or the rotational speed of the first energy machine is less than or equal to an m-th rotational speed threshold value n_{threshold,m}, that is to say when the following applies:

$${n}_{threshold , m - 1} > n \leq {n}_{threshold , m}$$

$$and / or$$

$${T}_{threshold , m - 1} > T \leq {T}_{threshold , m}$$

for example when the following applies:

$${n}_{threshold , m - 1} > n < {n}_{threshold , m}$$

$$and / or$$

$${T}_{threshold , m - 1} > T < {T}_{threshold , m}$$

where
n=rotational speed of the first energy machine
n_{threshold,m}=m rotational speed threshold value
n_{threshold,m-1}=m−1 rotational speed threshold value, where n_{threshold,0}=0
T=torque of the first energy machine
T_{threshold,m}=m torque threshold value
T_{threshold, m-1}=m−1 torque threshold value, where T_{threshold,0}=0

A shift point in the m−1 mode is present if n=n_{threshold,m-1} and/or T=T_{threshold,m-1}. A shift point in the m mode is present if n=n_{threshold,m} and/or T=T_{threshold,m}. Thus, if the rotational speed n of the first energy machine corresponds to one of the rotational speed threshold values and/or torque threshold values, a gear change, in particular a synchronized gear change, is performed into the next or the preceding mode or speed range. The gear change can take place under full load and without an interruption in tractive power and, in particular, can take place seamlessly. The first and the second energy machine can have the same rotational speed at the shift point. Owing to the seamless shifting, vibrations and/or shaking (“shift shock”) of the drive assembly can be avoided.

The control unit can be configured to compare the ascertained rotational speed and/or the ascertained torque with the rotational speed threshold value n_{threshold,m} and/or the torque threshold value T_{threshold,m}. The control unit can be configured to set and/or adjust the drive assembly, in particular the first and the second energy machine, into the m modes, in particular to operate same in the m modes, in accordance with the rotational speed and/or the torque. The control unit can be configured to set and/or adjust the drive assembly, in particular the first and the second energy machine, into the m−1 mode, in particular to operate same in the m−1 mode, in accordance with the rotational speed and/or the torque when the torque of the first energy machine is less than or equal to the torque threshold value T_{threshold,m} and/or the rotational speed of the first energy machine is less than or equal to the rotational speed threshold value n_{threshold,m}. Alternatively or in addition, the control unit can be configured to set and/or adjust the drive assembly, in particular the first and the second energy machine, into the m mode, in particular to operate same in the m mode, in accordance with the rotational speed and/or the torque when the torque of the first energy machine is greater than the torque threshold value T_{threshold,m} and/or the rotational speed of the first energy machine is greater than the rotational speed threshold value n_{threshold,m}.

In one possible embodiment, the drive assembly comprises a second power output, in particular a second mechanical power output. The second power output can drive the hydraulic system, in particular the hydraulic system of the work machine. The second power output can jointly comprise the second output shaft and the first power output. Alternatively, the second power output can comprise a third output shaft and/or be designed as a third output shaft. Likewise, the second power output can be a pump and/or compressor unit and/or a further power take-off unit, which can be similar in design to the power take-off unit. It is thus possible for a total of two power outputs and the travel drive to be implemented and/or operated independently of one another.

In one embodiment of the disclosure, the first energy machine, in particular only the first energy machine, is connected to the travel drive, and the second energy machine, in particular only the second energy machine, is connected to the first and/or the second power output, when a torque of the first energy machine is less than or equal to the torque threshold value and/or a rotational speed of the first energy machine is less than or equal to the rotational speed threshold value, for example when a torque of the first energy machine is less than the torque threshold value and/or a rotational speed of the first energy machine is less than the rotational speed threshold value. The following can thus apply in the first mode or the first speed range, it being possible, in particular, for the drive assembly to be operable as follows in the first mode or the first speed range:

The first energy machine can be connected, in particular coupled, to the travel drive and can drive same.

The second energy machine can be connected, in particular coupled, to the first and/or the second power output and can drive same.

In the second mode or the first speed range, i.e. when a torque of the first energy machine is greater than the torque threshold value and/or a rotational speed of the first energy machine is greater than the rotational speed threshold value, the following can apply, it being possible, in particular, for the drive assembly to be operable as follows in the second mode or the second speed range:

It is alternatively or additionally possible for the second energy machine, in particular only the second energy machine, to be connected to the travel drive. It is thus possible in particular for the second energy machine to be coupled to the travel drive and to drive same.

It is alternatively or additionally possible for the first energy machine not to be connected to the travel drive, in particular to be decoupled from the travel drive.

It is alternatively or additionally possible for the first energy machine to be connected to the first and/or the second power output. It is thus possible in particular for the first energy machine to be coupled to the first and/or the second power output and to drive same.

It is alternatively or additionally possible for the second energy machine to be connected to the travel drive and the first and/or the second power output. It is thus possible in particular for the second energy machine to be coupled to the travel drive and the first and/or the second power output and to drive same.

The drive assembly can comprise a fifth coupling device. The second energy machine can be connected to the fifth coupling device. In addition, the second energy machine can be connectable or connected to the second power output by means of or by the fifth coupling device. The fifth coupling device can be connectable or connected to the second or the third output shaft.

The fifth coupling device can in each case be movable between a first position, in particular a closed or connected or coupled state, and a second position, in particular an open or unconnected or decoupled state. In the first position, the fifth coupling device can be connected to another component, for example the second or the third output shaft. In the second position, it is possible for the fifth coupling devices not to be connected to the other component, i.e. to be released therefrom.

By means of or by the fifth coupling device, it is possible for the second energy machine to be connected to the second power output, in particular the second or the third output shaft, in the first position and not to be connected to the second or the third power output, in particular the second or the third output shaft, i.e. to be decoupled, in the second position.

The fifth coupling device can be designed as a clutch or synchronizer, for example as a shift clutch or a multiplate clutch or a synchromesh clutch or a switchable freewheel clutch.

The drive assembly can comprise a fifth transmission stage, in particular a fifth spur gear stage or a fifth gearwheel set or a fifth gearwheel pair. The second energy machine can be connected by or by means of the fifth transmission stage to the fifth coupling device.

The fifth coupling device can be connected to the control unit for signaling, and/or operatively coupled thereto and/or connected thereto for transmitting signals and/or carrying data. In particular, the drive assembly can comprise a fifth valve or a fifth valve assembly, in particular a fifth control valve, or a fifth actuator for controlling and/or setting and/or adjusting the fifth coupling device. The fifth valve or the fifth valve assembly or the fifth actuator can be connected to the fifth coupling device.

The control unit can be connected to the fifth valve or the fifth valve assembly or the fifth actuator for signaling, and/or operatively coupled thereto and/or connected thereto for transmitting signals and/or carrying data. The control unit can be configured to control and/or set and/or adjust the fifth coupling device, in particular via or by means of the fifth valve or the fifth valve assembly or the fifth actuator. The control unit can be configured to set and/or adjust the fifth coupling device, in particular via or by means of the fifth valve or the fifth valve assembly or the fifth actuator, into the first or the second position, in particular also to move said fifth coupling device from the first into the second position and vice versa. The drive assembly has the advantages set out above.

In one embodiment of the disclosure, the drive assembly comprises a third energy machine. The first energy machine, in particular only the first energy machine, is connected to the travel drive, and the second energy machine, in particular only the second energy machine, is connected to the first power output, and the third energy machine, in particular only the third energy machine, is connected to the second power output, when a torque of the first energy machine is less than or equal to the torque threshold value and/or a rotational speed of the first energy machine is less than or equal to the rotational speed threshold value, for example when a torque of the first energy machine is less than the torque threshold value and/or a rotational speed of the first energy machine is less than the rotational speed threshold value. The energy store or stores can be connected and/or couplable, in particular electrically connected and/or electrically couplable, to the third energy machine.

The third energy machine can be designed as an electric motor, in particular as a third electric motor. However, the third energy machine can also be a fuel cell or for example a permanent-magnet and/or electrically excited synchronous and/or asynchronous machine that is operated using direct current and/or three-phase current, such as a permanent-magnet three-phase synchronous machine. The third energy machine can be operable as a motor or a generator. The third energy machine can drive the drive assembly with a rotational speed and/or a torque. The third energy machine, in particular the third electric motor, can comprise a third drive shaft.

The following can thus apply in the first mode or the first speed range, it being possible, in particular, for the drive assembly to be operable as follows in the first mode or the first speed range:

The first energy machine can be connected, in particular coupled, to the travel drive and can drive same.

The second energy machine can be connected, in particular coupled, to the first power output and can drive same.

The third energy machine can be connected, in particular coupled, to the second power output and can drive same.

In the second mode or the second speed range, i.e. when a torque of the first energy machine is greater than the torque threshold value and/or a rotational speed of the first energy machine is greater than the rotational speed threshold value, the following can apply, it being possible, in particular, for the drive assembly to be operable as follows in the second mode or the second speed range:

It is alternatively or additionally possible for the second energy machine, in particular only the second energy machine, to be connected to the travel drive. It is thus possible in particular for the second energy machine to be coupled to the travel drive and to drive same.

It is alternatively or additionally possible for the first energy machine not to be connected to the travel drive, in particular to be decoupled from the travel drive.

It is alternatively or additionally possible for the first energy machine to be connected to the first and/or the second power output. It is thus possible in particular for the first energy machine to be coupled to the first and/or the second power output and to drive same.

It is alternatively or additionally possible for the third energy machine to be connected to the first and/or the second power output. It is thus possible in particular for the third energy machine to be coupled to the first and/or the second power output and to drive same.

It is alternatively or additionally possible for the second energy machine to be connected to the travel drive and the first and/or the second power output. It is thus possible in particular for the second energy machine to be coupled to the travel drive and the first and/or the second power output and to drive same.

Alternatively, instead of the second energy machine, the third energy machine can be connected to the fifth coupling device. In addition, the third energy machine can be connectable or connected to the second power output, in particular the second or the third output shaft, by means of or by the fifth coupling device. Alternatively, instead of the second energy machine, the third energy machine can be connected to the fifth coupling device.

In one embodiment of the disclosure, the first power output comprises a first angular gear set and/or the second power output comprises a second angular gear set. In one embodiment of the disclosure, the first electric motor and the travel drive, in particular the first output shaft, and/or the second electric motor and the travel drive, in particular the first output shaft, and/or the third electric motor and the travel drive, in particular the first output shaft, are arranged coaxially with or parallel to one another. More specifically, the axes of rotation of the first electric motor and/or of the second electric motor and/or of the third electric motor and/or of the travel drive, in particular the first output shaft, can be arranged coaxially with or parallel to one another.

The disclosure furthermore relates to an axle, in particular an electrically driven axle, for a work machine, comprising a drive assembly, in particular a drive assembly as disclosed herein.

The disclosure furthermore relates to a work machine, comprising an axle, in particular an axle as disclosed herein, and/or a drive assembly, in particular a drive assembly as disclosed herein. The work machine can be a construction machine or a towing vehicle, for example an agricultural towing vehicle, for example a tractor. The work machine has the above-described advantages of the drive assembly.

The work machine comprises the drive assembly. The drive assembly is designed for driving the work machine. The work machine can comprise one, two or more axle(s). More specifically, the work machine can comprise a first and a second vehicle axle. The axle, in particular the first and/or the second vehicle axle, can comprise the drive assembly. More specifically, the drive assembly can be integrated into the axle, in particular into the first and/or the second vehicle axle. The work machine can be driveable with a rotational speed and/or a force and/or a torque of the first and/or the second and/or the third energy machine. The first vehicle axle can be a front axle, in particular a steerable front axle, and/or the second vehicle axle can be a rear axle.

The control unit can be configured for exercising open-loop and/or closed-loop control over, in particular for setting and/or adjusting, the work machine, in particular the first and the second mode. The work machine can comprise an input and output unit. The control unit can be connected to the input and output unit for signaling, and/or operatively coupled and/or connected thereto for transmitting signals and/or carrying data, and/or can be controllable and/or settable and/or adjustable by means of the input and output unit. The input and output unit can be integrated into the control unit, or vice versa. The operator of the work machine can use the input and output unit to set and/or adjust a speed of the work machine, for example. The work machine can moreover comprise one or more auxiliary units, for example a pump and/or a radiator, etc. The auxiliary units can be part of the hydraulic system of the drive assembly. The work machine can comprise the first power output, in particular the power take-off unit. The control unit can be configured to set and/or adjust and/or control the drive assembly and/or the axle and/or the work machine by means of a driving signal, and to set and/or adjust, in particular to increase or decrease, a speed of the towing vehicle by means of or on the basis of the driving signal. The work machine can comprise the one or more ground-engaging means. The ground-engaging means can support and/or carry the work machine on the ground. A towing vehicle frame of the work machine can be supported on the ground-engaging means. The ground-engaging means can be wheels or tracks or chains. In particular, the ground-engaging means can be front wheels and rear wheels. The work machine can comprise a speed sensor for detecting a speed of the work machine. The control unit can be configured to set and/or adjust and/or control the drive assembly and/or the axle and/or the work machine, in particular the first and/or the second and/or the third energy machine and/or the power take-off unit, for example by virtue of the control unit being configured to set and/or adjust and/or control the valves and/or valve assemblies of these components. More specifically, the control unit can be configured to set and/or adjust and/or control a force and/or a torque and/or a rotational speed of the first and/or the second and/or the third energy machine.

The drive assembly or the axle or the work machine can comprise a set of power electronics. The set of power electronics and/or the energy store can be integrated into the control unit or be controllable as an external unit or as external units by the control unit. The set of power electronics can comprise an electronic control device and/or an inverter and/or a voltage transformer. During operation, the inverter can transform the voltage of the energy store into a voltage or energy or power that is required by the energy machine and/or the stator. This process can be reversed for the purposes of charging the energy store. The control unit can comprise a computing unit, a computer, a processor, a memory and/or all of the software, hardware, algorithms, connections, and in particular also sensors, that are required for setting and/or adjusting the first and/or the second and/or the third energy machine. The energy store can be controllable by a suitable set of control electronics in order to store electrical energy and/or power and/or to output same to the first and/or the second and/or the third energy machine. The control unit and/or the first and/or the second and/or the third energy machine can be electrically connected and/or electrically couplable to the set of power electronics and/or the energy store. Moreover, the supply of voltage and/or current and/or energy and/or power to the drive assembly, in particular the first and/or the second and/or the third energy machine and/or the energy store, can be controlled and/or settable and/or adjustable via or by means of the set of power electronics.

The first coupling device, in particular the first valve or the first valve device or the first actuator, and/or the second coupling device, in particular the second valve or the second valve device or the second actuator, and/or the third coupling device, in particular the third valve or the third valve device or the third actuator, and/or the fourth coupling device, in particular the fourth valve or the fourth valve device or the fourth actuator, and/or the fifth coupling device, in particular the fifth valve or the fifth valve device or the fifth actuator, and/or the energy store and/or the set of power electronics and/or the first and/or the second and/or the third energy machine and/or the first power output, in particular the power take-off unit, can be operable, for example controllable by open-loop and/or closed-loop control, such as activatable and/or settable and/or adjustable, by means of the control unit. The control unit can send and/or receive signals to control the operation of the drive assembly and/or the axle and/or the work machine. The signals can be expediently provided via a suitable data communication network, for example one that conforms to the ISOBUS and/or CAN standard. The control unit can be designed as an electronic module, an embedded system, a computing unit, a computer or a module for open-loop and/or closed-loop control of the drive assembly and/or the axle and/or the work machine. The control unit can comprise one or more processors, a memory and/or all of the software, hardware, algorithms, connections, and in particular also sensors, that are required for the open-loop and/or closed-loop control of the drive assembly and/or the axle and/or the work machine. Methods can take the form of a program or algorithm which can be executed on and/or by means of the control unit. The control unit can comprise any device which analyzes data from various sensors, compares data and makes the necessary decisions to exercise open-loop and closed-loop control over and/or carry out the operation of the drive assembly and/or the axle and/or the work machine and the necessary tasks for exercising open-loop and closed-loop control over the operation of the drive assembly and/or the axle and/or the work machine. The control device can be connected for signaling, and/or operatively coupled and/or connected for transmitting signals and/or carrying data, to the parts of the drive assembly and/or of the axle and/or of the work machine, i.e. in particular the travel drive and/or the first power output, in particular the power take-off unit, and/or the first coupling device, in particular the first valve or the first valve device or the first actuator, and/or the second coupling device, in particular the second valve or the second valve device or the second actuator, and/or the third coupling device, in particular the third valve or the third valve device or the third actuator, and/or the fourth coupling device, in particular the fourth valve or the fourth valve device or the fourth actuator, and/or the fifth coupling device, in particular the fifth valve or the fifth valve device or the fifth actuator, and/or the energy store and/or the set of power electronics and/or the first and/or the second and/or the third energy machine, and/or the sensors, for example the speed sensor and/or the rotational speed and/or torque sensor(s). Connected for signaling, and/or operatively coupled and/or connected for transmitting signals and/or carrying data, can be understood here as meaning, inter alia, that signals and/or data can be exchanged between the connected parts and the control unit. Signals can for example be received and transmitted, and/or processed and/or manipulated, by the control unit. The connection between the control unit and the parts or components of the drive assembly and/or the axle and/or the work machine can be implemented by wire, i.e. in particular using cables, and/or in a wireless manner, i.e. by radio, for example using Bluetooth or WLAN. The communication may take place for example by means of Isobus, CAN bus or the like. The control unit can be connected directly to the input and output unit, which is situated in a cab of the work machine and by means of which data entered by an operator can be transmitted to the control unit, or data can be received from the control unit and output. The control unit can be integrated into the input and output unit or vice versa.

The disclosure can furthermore relate to a method for operating the drive assembly, and/or the axle, and/or the work machine as disclosed herein.

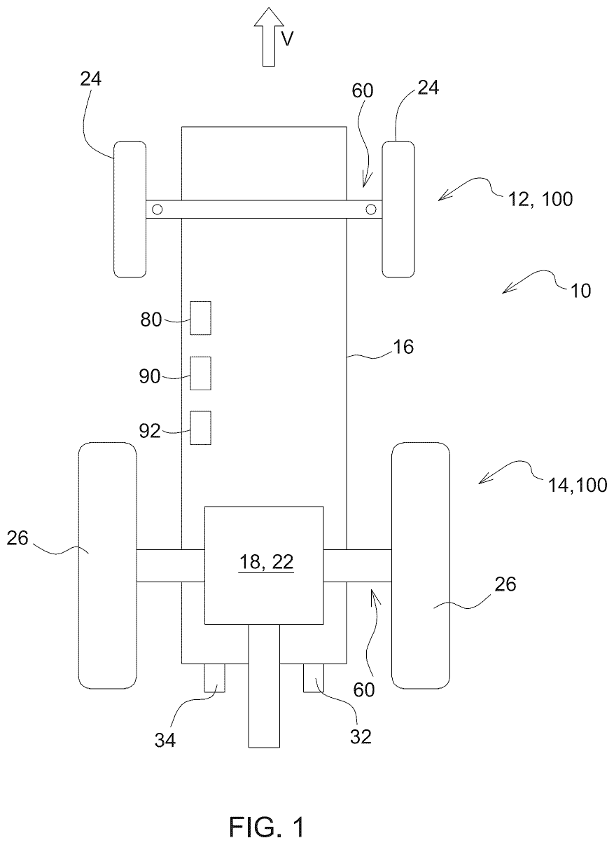

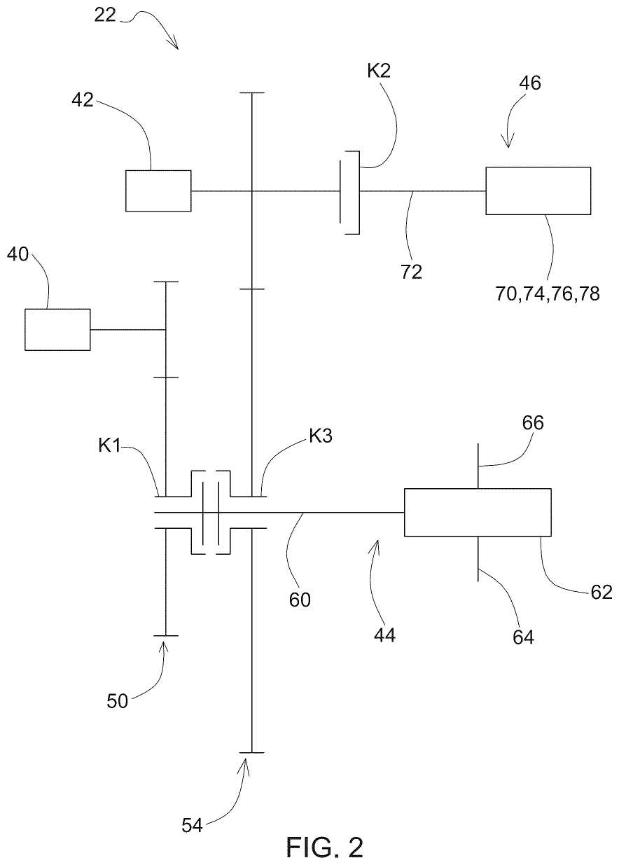

FIG. 1 shows a schematic illustration of a first example embodiment of a work machine 10, in particular an agricultural towing vehicle which is in the form of a farm tractor. The work machine 10, which is movable in a forward direction V, for example over a field, comprises a supporting frame 16, which is supported on the ground by two axles 100. The two axles 100 are designed as a first vehicle axle 12, in this case a steerable front axle having ground-engaging means 24, and a second vehicle axle 14, in this case a driveable rear axle having ground-engaging means 26. The work machine 10 comprises a drive assembly 22. The work machine 10, in particular the drive assembly 22 or the axle 100, can comprise an energy store 18, in this case, for example, a battery (rechargeable battery). The energy store 18 can be electrically connected to the drive assembly 22, in particular to a first and/or a second and/or a third energy machine 40, 42, 202 (see FIGS. 2 to 13) of the drive assembly 22. The drive assembly 22 is designed for mechanically driving a travel drive 44, in particular the axle 100, in this case the second vehicle axle 14, and/or a first power output 32. The first power output 32 can be designed as a power take-off unit and can be provided for the purposes of driving an implement (not shown), which can be attached to the work machine 10 via an interface 34 (for example three-point interface). The axle 100, in the present case the second vehicle axle 14, can comprise the drive assembly 22. It is however also possible for each axle 100, in particular the first and/or the second vehicle axle 12, 14, to each comprise a drive assembly 22. The work machine 10, but in particular alternatively also the axle 100 or the drive assembly 22, can comprise a control unit 80 and/or an input and output unit 90. The control unit 80 is connected to the first and/or the second and/or the third energy machine 40, 42, 202 for signaling, and/or operatively coupled thereto and/or connected thereto for transmitting signals and/or carrying data. The control unit 80 is configured to set and/or adjust the rotational speed and/or the torque of the drive assembly 22, in particular of the energy machines 40, 42, 202. The control unit 80 can be configured to set and/or adjust a specifiable rotational speed and/or a specifiable torque of the drive assembly 22, in particular of the energy machines 40, 42, 202. However, the control unit 80 can also be connected to the energy store 18 and/or to a set of power electronics 92 of the work machine 10, in particular alternatively of the axle 100 or the drive assembly 22, and/or to sensors of the drive assembly 22, in particular alternatively of the axle 100 or of the work machine 10, for signaling, and/or can be operatively coupled thereto and/or connected thereto for transmitting signals and/or carrying data. The control unit 80 can be configured to set and/or adjust the drive assembly 22 and/or the work machine 10 and/or the axle 100, for example to set and/or adjust the rotational speed and/or the torque of the first power output 32 and/or of the travel drive 44, in particular of the output shaft 60.

The energy store 18 supplies the electrically driven elements of the drive assembly 22, cf. FIGS. 2 to 7, in particular a first and/or a second and/or a third energy machine 40, 42, 202, with energy, in particular with currents or voltages of suitable frequency and amplitudes, in order to provide desired output rotational speeds or torques for the travel drive 44, and thus the second vehicle axle 14, and the first power output 32. The set of power electronics 92 can be electrically connected and/or electrically couplable to the first and/or the second and/or the third energy machine 40, 42, 202 and/or to the energy store 18. The first and/or the second and/or the third energy machine 40, 42, 202 and the travel drive 44, in particular the first output shaft 60, can be arranged coaxially with or parallel to one another.

FIG. 2 shows a schematic illustration of the first example embodiment of the drive assembly 22 according to the disclosure. The drive assembly 22 shown in FIG. 2 corresponds substantially to the drive assembly 22 shown in FIG. 1, and therefore only details and/or points of differentiation will be discussed below. The work machine 10 illustrated in FIG. 1 can comprise the drive assembly 22 illustrated in FIG. 2. The drive assembly 22 comprises a first and a second energy machine 40, 42 and a travel drive 44 and a first power output 46. In the first mode, when the torque of the first energy machine 40 is less than the torque threshold value and/or the rotational speed of the first energy machine 40 is less than the rotational speed threshold value, the first energy machine 40 is connected to, i.e. in particular is coupled to and drives, the travel drive 44, and the second energy machine 42 is connected to, i.e. in particular is coupled to and drives, the first power output 46. In the second mode, when the torque of the first energy machine 40 is greater than the torque threshold value and/or the rotational speed of the first energy machine 40 is greater than the rotational speed threshold value, the second energy machine 42 is connected to, i.e. in particular is coupled to and drives, the travel drive 44. It is furthermore alternatively possible in the second mode for the second energy machine 42 to be connected to, i.e. in particular to be coupled to and to drive, the travel drive 44 and the first power output 44.

The drive assembly 22 comprises a first coupling device K1, wherein the first energy machine 40 is connected to the first coupling device K1. The first energy machine 40 is connectable or connected by means of or by the first coupling device K1 to the travel drive 44. The drive assembly 22 furthermore comprises a second coupling device K2. The second energy machine 42 is connectable or connected by means of or by the second coupling device K2 to the first power output 46. The drive assembly 22 furthermore comprises a third coupling device K3. The second energy machine 42 is connectable by means of or by the third coupling device K3 to the travel drive 44.

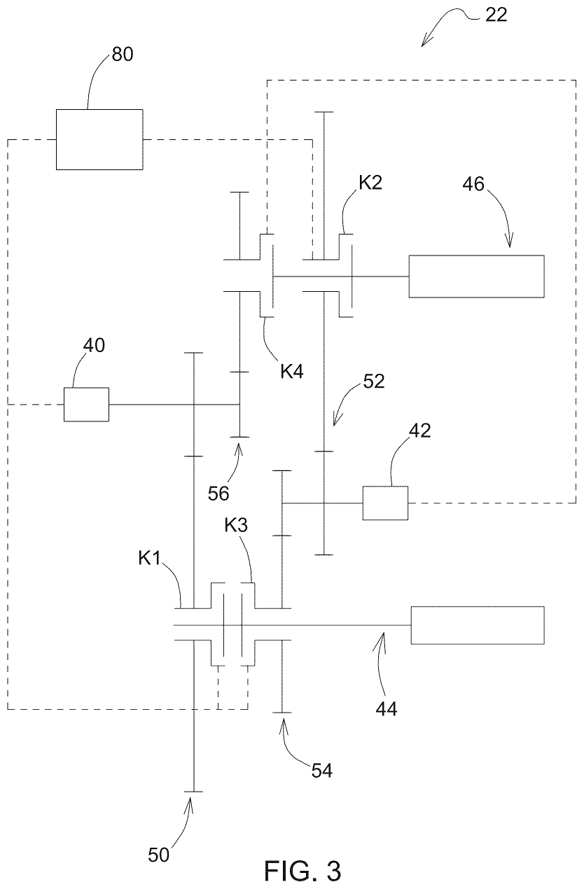

The drive assembly 22 furthermore comprises a first and a third transmission stage 50, 54. The first energy machine 40 is connected by or by means of the first transmission stage 50 to the first coupling device K1. The second energy machine 42 is connected by or by means of the third transmission stage 54 to the third coupling device K3. The first and the second and the third coupling device K1, K2, K3 are connected to the control unit 80 (see FIG. 3), in particular for signaling, and/or are operatively coupled thereto and/or connected thereto for transmitting signals and/or carrying data. The first, second and third coupling devices K1, K2, K3 can be settable and/or adjustable between the first position and the second position, in particular also can be movable from the first into the second position and vice versa (for details, see above).

The travel drive 44 is designed as a first output shaft 60 and a differential 62. However, the travel drive 44 may also comprise only the first output shaft 60 and/or be designed only as the first output shaft 60. The differential 62 is connected on the drive side to the first output shaft 60. In addition, the differential 62 can be connected on the driven side to a left-hand shaft 64 and to a right-hand shaft 66 in order to drive ground-engaging means 26 on the axle 14, 100. The first output shaft 60 can be designed as a hollow shaft, which in particular partially or completely surrounds the left-hand and/or the right-hand shaft 64, 66. The shafts 64, 66 are rigidly connected to the driven outputs of the differential 62.

The drive assembly 22 comprises the first power output 46. The first power output 46 can be designed as and/or comprise a power take-off unit 70. The power take-off unit 70 can comprise a power take-off gear set 74 and/or a power take-off shaft 76 and/or the second output shaft 72. The power take-off unit 70, in particular the power take-off gear set 74, can be connected on the drive side to the second output shaft 72. In addition, the power take-off unit 70 can be connected on the driven side to the power take-off shaft 76. However, the first power output 46 may also comprise only the second output shaft 72 and/or be designed only as the second output shaft 72. The first power output 46 can furthermore comprise a first angular gear set 76 and/or a second angular gear set 78. It is likewise possible for a second power output 400 to comprise the second angular gear set 78.

FIG. 3 shows a schematic illustration of a second example embodiment of the drive assembly 22 according to the disclosure. The drive assembly 22 shown in FIG. 3 corresponds substantially to the drive assembly 22 shown in FIGS. 1 and 2, and therefore only details and/or points of differentiation will be discussed below. The work machine 10 illustrated in FIG. 1 can comprise the drive assembly 22 illustrated in FIG. 3. The drive assembly 22 comprises a fourth coupling device K4, wherein the first energy machine 40 is connected to the fourth coupling device K4. The first energy machine 40 is connectable or connected by means of or by the fourth coupling device K4 to the first power output 46. The drive assembly 22 furthermore comprises a second and a fourth transmission stage 52, 56. The first energy machine 40 is connected by or by means of the fourth transmission stage 56 to the fourth coupling device K4. The second energy machine 42 is connected by or by means of the second transmission stage 52 to the second coupling device K2. The fourth coupling device K4 can likewise be settable and/or adjustable between the first position and the second position, in particular also can be movable from the first into the second position and vice versa (for details, see above).

The first, second, third and fourth coupling devices K1, K2, K3, K4 are connected to the control unit 80, in particular for signaling, and/or are operatively coupled thereto and/or connected thereto for transmitting signals and/or carrying data (see dashed line). More specifically, the drive assembly 22, in particular the first coupling device K1, can comprise a first valve or a first valve assembly (not shown), in particular a first control valve, or a first actuator for controlling and/or setting and/or adjusting the first coupling device K1. The drive assembly 22, in particular the second coupling device K2, can likewise comprise a second valve or a second valve assembly (not shown), in particular a second control valve, or a second actuator for controlling and/or setting and/or adjusting the second coupling device K2. The drive assembly 22, in particular the third coupling device K3, can likewise comprise a third valve or a third valve assembly (not shown), in particular a third control valve, or a third actuator for controlling and/or setting and/or adjusting the third coupling device K3. The drive assembly, in particular the fourth coupling device K4, can likewise comprise a fourth valve or a fourth valve assembly (not shown), in particular a fourth control valve, or a fourth actuator for controlling and/or setting and/or adjusting the fourth coupling device K4. The control unit 80 can be connected to the first and/or the second and/or the third and/or the fourth valve and/or to the first and/or the second and/or the third and/or the fourth valve assembly and/or to the first and/or the second and/or the third and/or the fourth actuator for signaling, and/or can be operatively coupled thereto and/or connected thereto for transmitting signals and/or carrying data. The control unit 80 can be configured to control and/or set and/or adjust the coupling devices K1, K2, K3, K4, in particular by means of the valves or the valve assemblies, for example to set and/or adjust said coupling devices into the first or the second position, in particular also to move said coupling devices from the first into the second position and vice versa.

The control unit 80 is connected to the first and the second energy machine 40, 42 for signaling, and/or operatively coupled thereto and/or connected thereto for transmitting signals and/or carrying data. The control unit can be configured to set and/or adjust the drive assembly 22, in particular the first and the second energy machine 40, 42, into the first or the second mode, in particular to operate same in the first or the second mode, in accordance with the rotational speed and/or the torque. The control unit 80 can be configured to set and/or adjust and/or control, i.e. in particular to exercise open-loop and closed-loop control over, the drive assembly 22 and thus also the work machine 10 by means of or in accordance with the rotational speed and/or the torque of the first energy machine 40. The control unit 80 can in particular also be present, with the same functionality and connections, in the embodiments in FIGS. 1, 2 and 4 to 5, even if the control unit 80 is not shown.

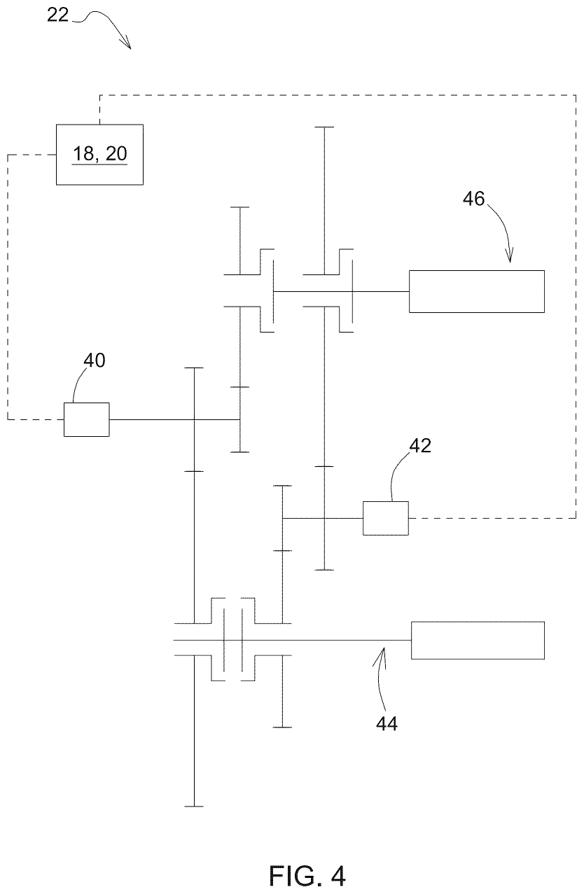

FIG. 4 shows a schematic illustration of a third example embodiment of the drive assembly 22 according to the disclosure. The drive assembly 22 shown in FIG. 4 corresponds substantially to the drive assembly 22 shown in FIGS. 1 to 3, and therefore only details and/or points of differentiation will be discussed below. The work machine 10 illustrated in FIG. 1 can comprise the drive assembly 22 illustrated in FIG. 4.

In the embodiment illustrated, the work vehicle 10 is driven by purely electric means, for which purpose an energy store 18, in this case a battery (rechargeable battery) is used. The energy store 18 is connected electrically to a drive assembly 22. The energy supply for the drive assembly 22 is provided electrically by means of the energy store 18. The control unit 80 can be connected to the energy store. The energy store 18 can likewise comprise a controller 20. The controller 20 can be configured to set and/or adjust the energy store. The controller 20 can be configured to supply the electrically driven elements of the drive assembly 22 with currents or voltages of suitable frequency and amplitudes.

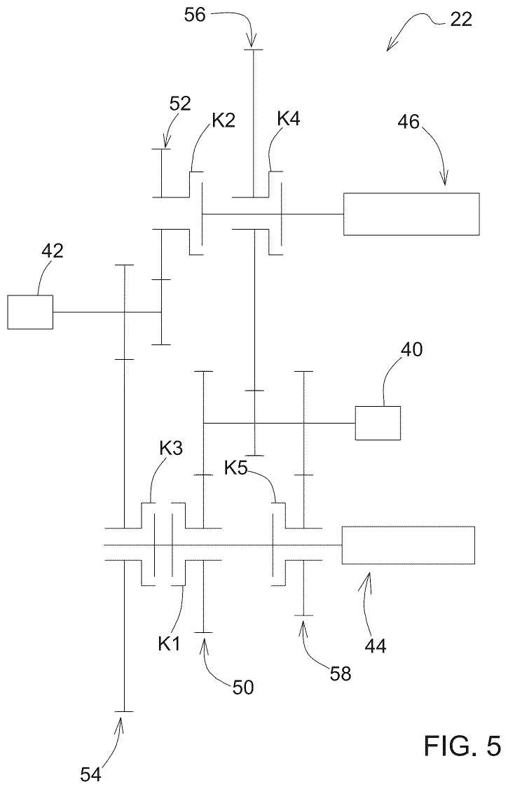

FIG. 5 shows a schematic illustration of a fourth example embodiment of the drive assembly 22 according to the disclosure. The drive assembly 22 shown in FIG. 5 corresponds substantially to the drive assembly 22 shown in FIGS. 1 to 4, and therefore only details and/or points of differentiation will be discussed below. The work machine 10 illustrated in FIG. 1 can comprise the drive assembly 22 illustrated in FIG. 5.

In order to implement a drive assembly 22 having three drive stages (m=3) for the travel drive 44 and one shift point (t=1), in particular shift point with seamless shiftability, at the first power output 46, the drive assembly 22 comprises five coupling devices K1, K2, K3, K4, K5 (m+t+1=5). The drive assembly 22 additionally comprises three transmission stages 50, 54, 58, which are connectable or connected to the travel drive 44, and two transmission stages 52, 56, which are connectable or connected to the first power output 46. It is important that the uneven and even gears are assigned to separate energy machines 40, 42 in order to allow shifting between the gears. FIG. 5 shows a drive assembly 22 having 3 gears and having a first and a third mode, which are implemented by means of the first energy machine 40, and a second mode, which is implemented by means of the second energy machine 42. The shifting of the travel drive 44 and of a shift point of the first power output 46 takes place seamlessly.

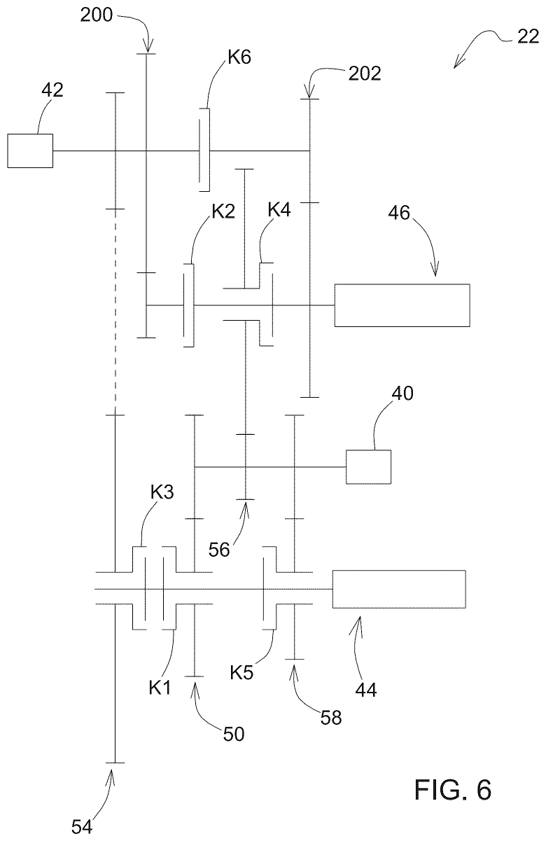

FIG. 6 shows a schematic illustration of a fifth example embodiment of the drive assembly 22 according to the disclosure. The drive assembly 22 shown in FIG. 6 corresponds substantially to the drive assembly 22 shown in FIGS. 1 to 5, and therefore only details and/or points of differentiation will be discussed below. The work machine 10 illustrated in FIG. 1 can comprise the drive assembly 22 illustrated in FIG. 6.

In order to implement a drive assembly 22 having 3 drive stages (m=3) for the travel drive and two shift points (t=2), in particular shift points with seamless shiftability, at the first power output 46, this drive assembly comprises six coupling devices K1, K2, K3, K4, K5, K6 (m+t+1=6). The drive assembly 22 additionally comprises three transmission stages 50, 54, 58, which are connectable or connected to the travel drive 44, and three transmission stages 56, 200, 202, which are connectable or connected to the first power output 46. Here, the transmission stages 200, 202 are connectable or connected only by means of or by the coupling device K6 to the first power output 46. It can thus be achieved that two shift points, in particular shift points with seamless shiftability, are implemented at the first power output 46.

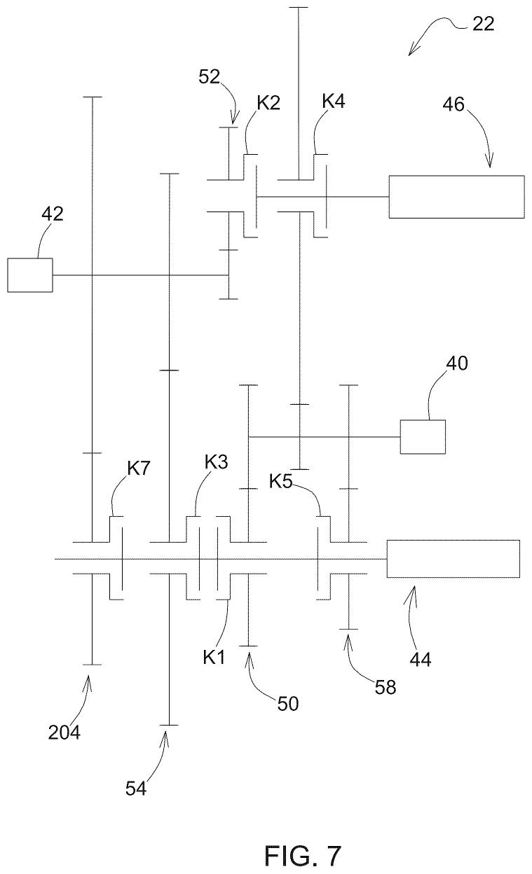

FIG. 7 shows a schematic illustration of a sixth example embodiment of the drive assembly 22 according to the disclosure. The drive assembly 22 shown in FIG. 7 corresponds substantially to the drive assembly 22 shown in FIGS. 1 to 6, and therefore only details and/or points of differentiation will be discussed below. The work machine 10 illustrated in FIG. 1 can comprise the drive assembly 22 illustrated in FIG. 7. The drive assembly 22 shown in FIG. 7 is implemented with four drive stages (m=4) for the travel drive 44 and one shift point (t=1), in particular shift point with seamless shiftability, at the first power output 46, by virtue of the drive assembly 22 comprising six coupling devices K1, K2, K3, K4, K5, K7 (m+t+1=6). In relation to FIG. 5, the drive assembly 22 additionally comprises a further transmission stage 204, which is connectable or connected to the travel drive 44. Only seamless shifting of the first power output 46 is possible, whereas the travel drive 42 is shifted once depending on the transmission conditions selected between the two energy machines 40, 42 and the first power output 46. Shifting operations up to the third gear function in the same way as in a synchronized 3-gear transmission. Seamless shifting of the travel drive 44 from gear 3 to gear 4 can be achieved by engaging the coupling device K7 and disengaging K5, which has the effect that the second energy machine drives the travel drive. To also operate the first power output 46 at this high rotational speed, the first energy machine 40 can be coupled to the first power output 46 again via K4.

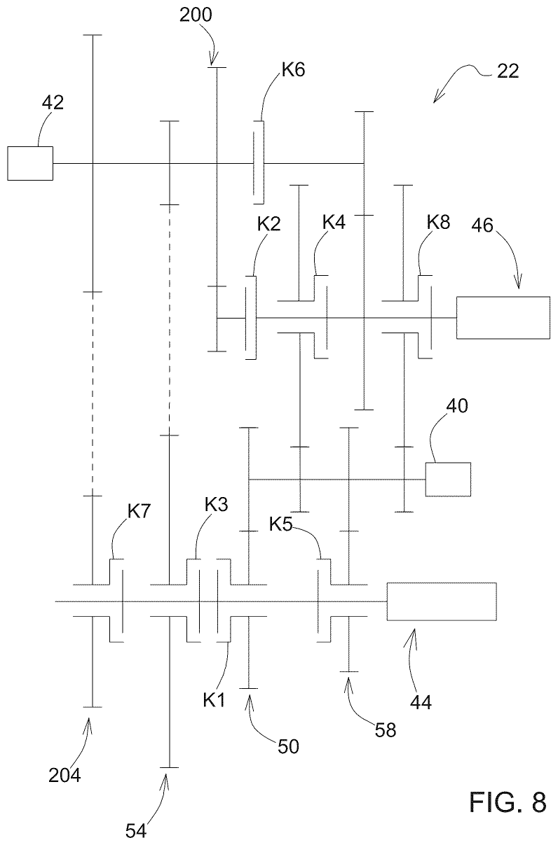

FIG. 8 shows a schematic illustration of a seventh example embodiment of the drive assembly 22 according to the disclosure. The drive assembly 22 shown in FIG. 8 corresponds substantially to the drive assembly 22 shown in FIGS. 1 to 7, and therefore only details and/or points of differentiation will be discussed below. The work machine 10 illustrated in FIG. 1 can comprise the drive assembly 22 illustrated in FIG. 8. The drive assembly 22 shown in FIG. 8 is implemented with four drive stages (m=4) for the travel drive 44 and three shift points (t=3), in particular shift points with seamless shiftability, at the first power output 46, by virtue of the drive assembly 22 comprising eight coupling devices K1, K2, K3, K4, K5, K6, K7, K8 (m+t+1=8).

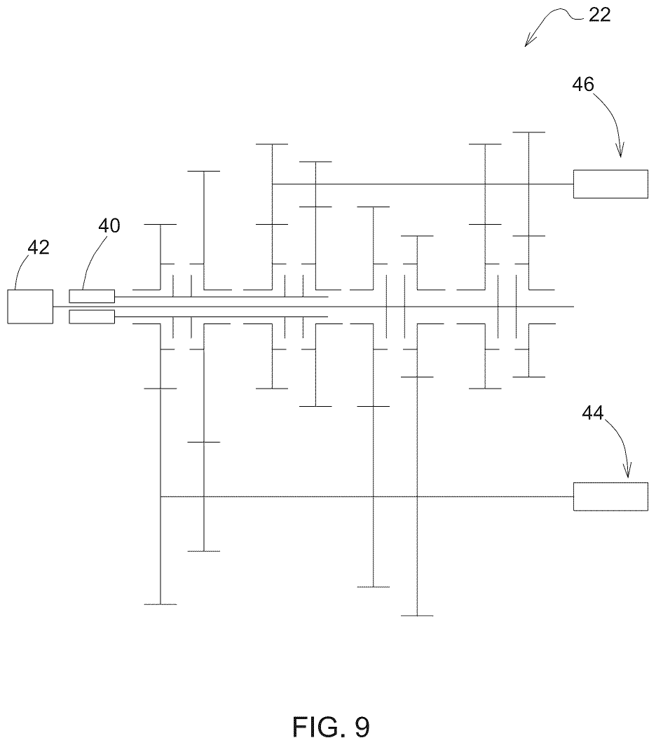

FIG. 9 shows a schematic illustration of an eighth example embodiment of the drive assembly 22 according to the disclosure. The drive assembly 22 shown in FIG. 9 corresponds substantially to the drive assembly 22 shown in FIGS. 1 to 8, and therefore only details and/or points of differentiation will be discussed below. The work machine 10 illustrated in FIG. 1 can comprise the drive assembly 22 illustrated in FIG. 9. FIG. 9 shows an alternating configuration for different values of m and t.

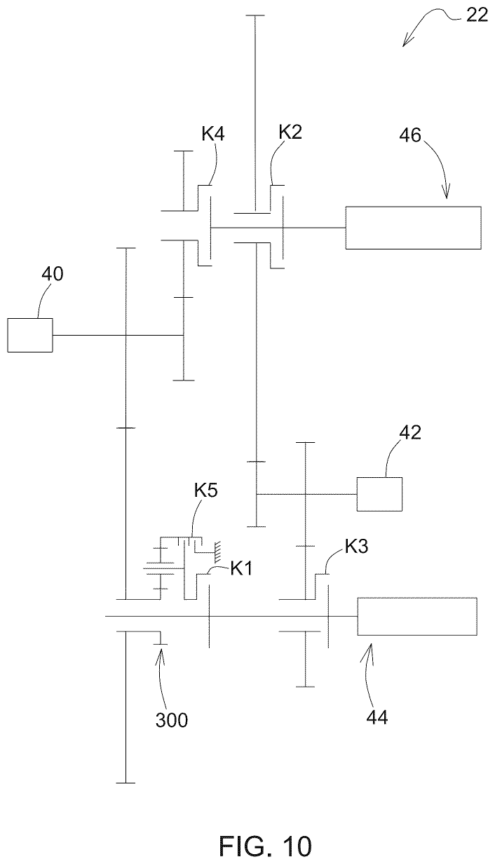

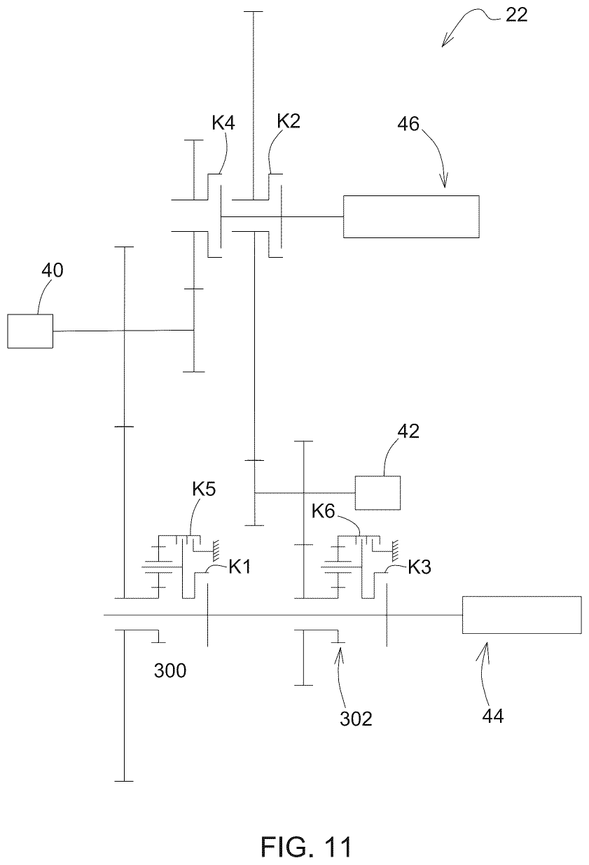

FIGS. 10 and 11 show schematic illustrations of an eighth and a ninth example embodiment of the drive assembly 22 according to the disclosure. The drive assemblies 22 shown in FIGS. 10 and 11 correspond substantially to the drive assembly 22 shown in FIGS. 1 to 9, and therefore only details and/or points of differentiation will be discussed below. The work machine 10 illustrated in FIG. 1 can comprise the drive assemblies 22 illustrated in FIGS. 10 and 11. FIGS. 10 and 11 show drive assemblies 22 having planetary gear sets 300, 302, in particular shiftable planetary gear sets 300, 302, which makes the drive assembly 22 compact and/or, depending on where the planetary gear sets 300, 302 are situated, makes it possible to implement multiple shift points, in particular seamless shift points, of the first power output 46. It is then the case that the drive assembly 22 comprises x=m+1 coupling devices K1, K2, K3, K4, K5. The drive assembly in FIG. 10 has three drive stages (m=3). The drive assembly 22 in FIG. 11 has four drive stages (m=4). In the drive assemblies 22 illustrated in FIGS. 10 and 11, seamless shift operations for the first power output 46 are achieved by virtue of the first and the second energy machine 40, 42 being designed such that a certain rotational speed range remains for the 3rd and 4th gears of the travel drive 44. If this is not possible, then the shift operations for the 3rd and 4th gears of the first power output are implemented by means of powershift operations, because an adjustment of the rotational speed of the electric machine is required for the shift operations.

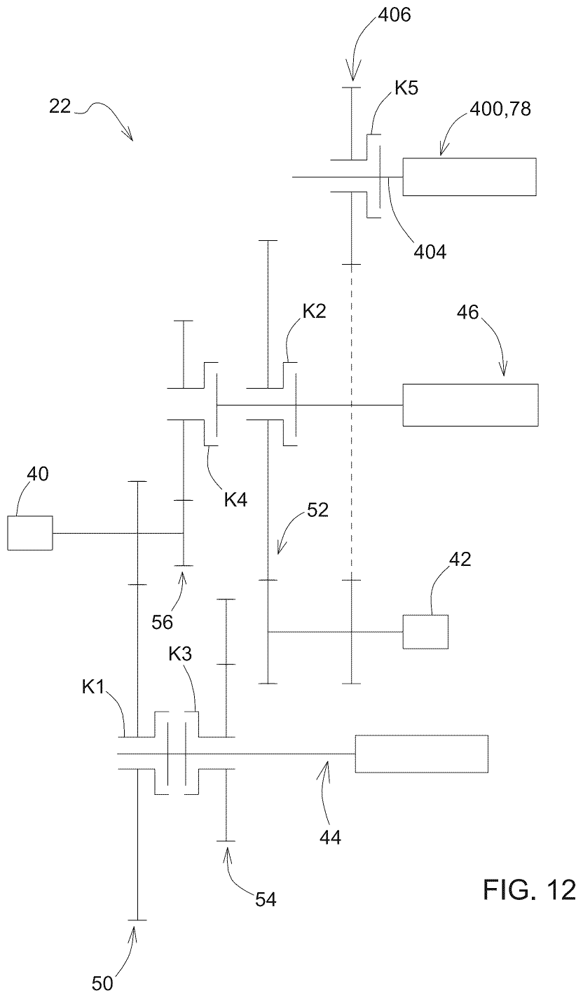

FIG. 12 shows a schematic illustration of a further example embodiment of the drive assembly 22 according to the disclosure. The drive assembly 22 shown in FIG. 12 corresponds substantially to the drive assembly 22 shown in FIGS. 1 to 11, and therefore only details and/or points of differentiation will be discussed below. The work machine 10 illustrated in FIG. 1 can comprise the drive assembly 22 illustrated in FIG. 12. The drive assembly 22 comprises a second power output 400. The second power output 400 can comprise a third output shaft 404 and/or be designed as a third output shaft 404. The second power output 400 can however also be designed as or comprise a further power take-off unit. The further power take-off unit can be of identical design to the power take-off unit 70. Alternatively or in addition, the second power output 400 can be connected to the hydraulic system, for example a pump and/or compressor unit. The second power output 400 can comprise the second angular gear set 78. The first energy machine 40 is connected to the travel drive 44, and the second energy machine 42 is connected to the first and/or the second power output 46, 200, when a rotational speed n of the first energy machine 40 is less than or equal to a rotational speed threshold value n_{threshold}, for example when a rotational speed n of the first energy machine 40 is less than the rotational speed threshold value n_{threshold}, and the second energy machine 42 is connected to the travel drive 44 when a rotational speed n of the first energy machine 40 is greater than the rotational speed threshold value n_{threshold}. By means of the fifth or by the fifth coupling device K5, it is possible for the second energy machine 42 to be connected to the second power output 400, in particular the second or third output shaft 72, 404, in the first position, and not to be connected to the second or third power output 46, 400, in particular the second or third output shaft 72, 404, i.e. to be decoupled, in the second position. The drive assembly 22 can comprise a fifth transmission stage 406. The second energy machine 42 can be connected by or by means of the fifth transmission stage 406 to the fifth coupling device K5.

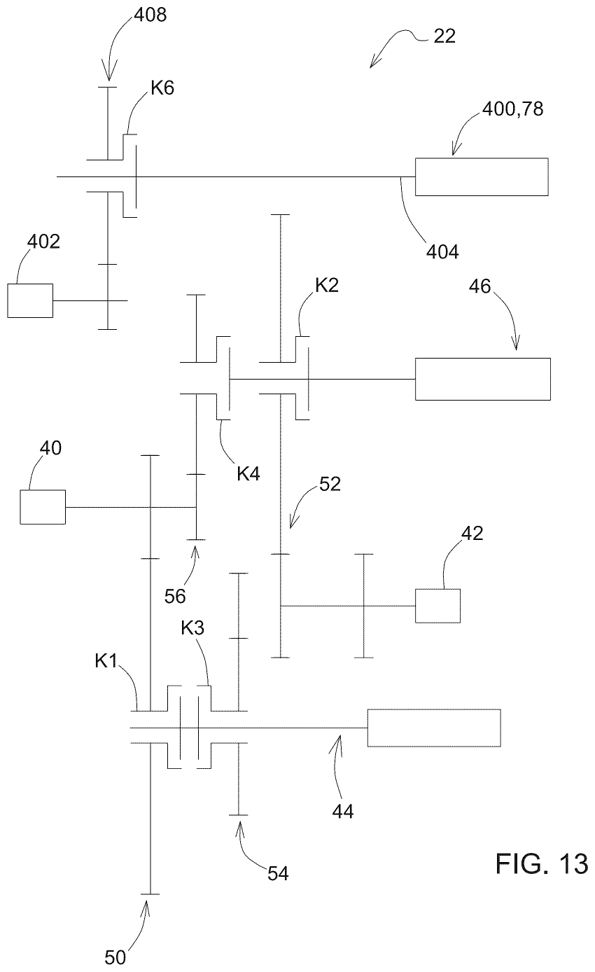

FIG. 13 shows a schematic illustration of a further example embodiment of the drive assembly 22 according to the disclosure. The drive assembly 22 shown in FIG. 13 corresponds substantially to the drive assembly 22 shown in FIGS. 1 to 12, and therefore only details and/or points of differentiation will be discussed below. The work machine 10 illustrated in FIG. 1 can comprise the drive assembly 22 illustrated in FIG. 13. The drive assembly 22 comprises a third energy machine 402. The third energy machine 402 is connected to the second power output 400. Alternatively or in addition, the third energy machine 402 can be connected to the second power output 400 when a rotational speed n of the first energy machine 40 is less than or equal to the rotational speed threshold value n_{threshold}, for example when a rotational speed n of the first energy machine 40 is less than the rotational speed threshold value n_{threshold}. By means of or by the sixth coupling device K6, it is possible for the third energy machine 402 to be connected to the second power output 400, in particular the third output shaft 404, in the first position, and not to be connected to the second power output 400, in particular the third output shaft 404, i.e. to be decoupled, in the second position. The drive assembly 22 can comprise the sixth transmission stage 408. The third energy machine 402 can be connected by or by means of the sixth transmission stage 408 to the sixth coupling device K6. The first and/or the second and/or the third electric motor 40, 42, 402 and/or the travel drive 44 can be arranged coaxially with or parallel to one another.

All of the embodiments of the drive assembly 22 which are shown are distinguished by a compact construction and/or their shiftability, in particular synchronized and/or seamless shiftability.

The terminology used herein is for the purpose of describing example embodiments or implementations and is not intended to be limiting of the disclosure. As used herein, the singular forms “a,” “an,” and “the” are intended to include the plural forms as well, unless the context clearly indicates otherwise. It will be further understood that the any use of the terms “has,” “includes,” “comprises,” or the like, in this specification, identifies the presence of stated features, integers, steps, operations, elements, and/or components, but does not preclude the presence or addition of one or more other features, integers, steps, operations, elements, components, and/or groups thereof.

Those having ordinary skill in the art will recognize that terms such as “above,” “below,” “upward,” “downward,” “top,” “bottom,” etc., are used descriptively for the drawings, and do not represent limitations on the scope of the present disclosure, as defined by the appended claims. Furthermore, the teachings may be described herein in terms of functional and/or logical block components or various processing steps, which may include any number of hardware, software, and/or firmware components configured to perform the specified functions.

Terms of degree, such as “generally,” “substantially,” or “approximately” are understood by those having ordinary skill in the art to refer to reasonable ranges outside of a given value or orientation, for example, general tolerances or positional relationships associated with manufacturing, assembly, and use of the described embodiments or implementations.

As used herein, “e.g.,” is utilized to non-exhaustively list examples and carries the same meaning as alternative illustrative phrases such as “including,” “including, but not limited to,” and “including without limitation.” Unless otherwise limited or modified, lists with elements that are separated by conjunctive terms (e.g., “and”) and that are also preceded by the phrase “one or more of” or “at least one of” indicate configurations or arrangements that potentially include individual elements of the list, or any combination thereof. For example, “at least one of A, B, and C” or “one or more of A, B, and C” indicates the possibilities of only A, only B, only C, or any combination of two or more of A, B, and C (e.g., A and B; B and C; A and C; or A, B, and C).

While the above describes example embodiments or implementations of the present disclosure, these descriptions should not be viewed in a restrictive or limiting sense. Rather, there are several variations and modifications which may be made without departing from the scope of the appended claims.

What is claimed is:

1. A drive assembly for a work machine, comprising:
a first and a second energy machine;
a travel drive;
a first power output; and
a plurality of coupling devices equal to one more than a sum of at least two drive stages at the travel drive and shift points at the first power output, the first energy machine being connectable by at least one of the plurality of coupling devices to the travel drive, the second energy machine being connectable by at least one of the plurality of coupling devices to the travel drive, and the second energy machine being connectable by at least one of the plurality of coupling devices to the first power output.

2. The drive assembly of claim 1, wherein:
the first energy machine is connectable via a first coupling device of the plurality of coupling devices to the travel drive;
the second energy machine is connectable via a second coupling device of the plurality of coupling devices to the first power output;
the second energy machine is connectable via a third coupling device of the plurality of coupling devices to the travel drive; and
the first energy machine is connectable via a fourth coupling device of the plurality of coupling devices to the first power output.

3. The drive assembly of claim 1, wherein:
the first energy machine is connected to the travel drive;
the second energy machine is connected to the first power output when a rotational speed of the first energy machine is less than or equal to a rotational speed threshold value; and
the second energy machine is connected to the travel drive when the rotational speed of the first energy machine is greater than the rotational speed threshold value.

4. The drive assembly of claim 3, wherein one of:
the second energy machine is connected to the travel drive and to the first power output when the rotational speed of the first energy machine is greater than the rotational speed threshold value; or
the second energy machine is connected to the travel drive, and the first energy machine is connected to the first power output, when the rotational speed of the first energy machine is greater than the rotational speed threshold value.

5. The drive assembly of claim 1, further comprising:
a second power output.

6. The drive assembly of claim 5, wherein:
the first energy machine is connected to the travel drive;
the second energy machine is connected to the first and the second power output or to the second power output when a rotational speed of the first energy machine is less than a rotational speed threshold value; and
the second energy machine is connected to the travel drive when the rotational speed of the first energy machine is greater than the rotational speed threshold value.

7. The drive assembly of claim 6, further comprising:
a third energy machine being connected to the second power output.

8. The drive assembly of claim 5, wherein one of the first power output includes a first angular gear set and a second angular gear set, or the second power output includes the second angular gear set.

9. The drive assembly of claim 7, wherein the first, second, and third energy machines and the travel drive are arranged coaxially with or parallel to one another.

10. A work machine, comprising the drive assembly of claim 1.

11. An axle for a work machine including a drive assembly, comprising:
a first and a second energy machine;
a travel drive;
a first power output; and
a plurality of coupling devices equal to one more than a sum of at least two drive stages at the travel drive and shift points at the first power output, the first energy machine being connectable by at least one of the plurality of coupling devices to the travel drive, the second energy machine being connectable by at least one of the plurality of coupling devices to the travel drive, and the second energy machine being connectable by at least one of the plurality of coupling devices to the first power output.

12. The axle of claim 11, wherein:
the first energy machine is connectable via a first coupling device of the plurality of coupling devices to the travel drive;
the second energy machine is connectable via a second coupling device of the plurality of coupling devices to the first power output;
the second energy machine is connectable via a third coupling device of the plurality of coupling devices to the travel drive; and
the first energy machine is connectable via a fourth coupling device of the plurality of coupling devices to the first power output.

13. The axle of claim 11, wherein:
the first energy machine is connected to the travel drive;
the second energy machine is connected to the first power output when a rotational speed of the first energy machine is less than or equal to a rotational speed threshold value; and
the second energy machine is connected to the travel drive when the rotational speed of the first energy machine is greater than the rotational speed threshold value.

14. The axle of claim 13, wherein one of:
the second energy machine is connected to the travel drive and to the first power output when the rotational speed of the first energy machine is greater than the rotational speed threshold value; or
the second energy machine is connected to the travel drive, and the first energy machine is connected to the first power output, when the rotational speed of the first energy machine is greater than the rotational speed threshold value.

15. The axle of claim 11, further comprising:
a second power output.

16. The axle of claim 15, wherein:
the first energy machine is connected to the travel drive;
the second energy machine is connected to the first and the second power output or to the second power output when a rotational speed of the first energy machine is less than a rotational speed threshold value; and
the second energy machine is connected to the travel drive when the rotational speed of the first energy machine is greater than the rotational speed threshold value.

17. The axle of claim 15, further comprising:
a third energy machine being connected to the second power output.

18. The axle of claim 15, wherein one of the first power output includes a first angular gear set and a second angular gear set, or the second power output includes the second angular gear set.

19. The axle of claim 17, wherein the first, second, and third energy machines and the travel drive are arranged coaxially with or parallel to one another.

20. A work machine, comprising the axle of claim 11.
